(19) United States
(12) Patent Application Publication
(10) Pub. No.: US 2009/0193280 A1
(43) Pub. Date: Jul. 30, 2009

(54) Method and System for In-doubt Resolution in Transaction Processing

(76) Inventors: Michael David Brooks, Southampton (GB); Andrew Wright, Eastleigh (GB)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/022,223

(22) Filed: Jan. 30, 2008

(51) Int. Cl. G06F 1/12

(52) U.S. Cl. 713/400

(57) ABSTRACT

A method and system are provided for in-doubt resolution in transaction processing involving at least two distributed transaction processing systems. The method includes a resynchronization method when re-establishing a connection between two distributed transaction processing systems. The method includes re-establishing a connection between a first transaction processing system and a second transaction processing system following a failure; the first transaction processing system searching for any unresolved units of recovery and resynchronizing each unresolved unit of recovery with the second transaction processing system; and when the first transaction processing system has finished processing its unresolved units of recovery, the second transaction processing system then searches for any unresolved units of recovery and resynchronizes each unresolved unit of recovery with the first transaction processing system.

### CROSS-REFERENCE TO RELATED APPLICATION

This application claims subject matter that is related to GB920070091US1, Ser. No. ______, entitled: Method and System for In-Doubt Resolution in Transaction Processing, filed ______. Inventors: Michael David Brooks and Andrew Wright and assigned to International Business Machines Corporation (IBM).

### FIELD OF THE INVENTION

This invention relates to the field of in-doubt resolution in transaction processing. In particular, the invention relates to in-doubt resolution of units of recovery in distributed transaction processing.

### BACKGROUND OF THE INVENTION

A distributed transaction is a set of operations in which two or more network hosts are involved providing transaction resources. A transaction manager is responsible for creating and managing a distributed or global transaction that encompasses all operations against the transaction resources. Distributed transactions, as with other transactions, must have atomicity guarantees for the outcome of the unit of recovery. A common algorithm for ensuring correct completion of a distributed transaction is the two-phase commit protocol.

The two-phase commit protocol is a distributed algorithm that lets all nodes in a distributed system agree to commit a transaction. The protocol results in either all nodes committing the transaction or aborting.

A transaction resource might be left with in-doubt units of recovery if contact with the transaction manager is lost after the transaction resource has been instructed to prepare. Until the transaction resource receives the outcome from the transaction manager (commit or roll back), it needs to retain the locks associated with the updates. These locks prevent other applications from updating or reading the resource, therefore resynchronization needs to take place as soon as possible.

Each transaction resource can carry out recovery actions in a unit of recovery in the case of a failure or error. In a distributed transaction processing environment, units of recovery can inter-operate over a communication network and jointly perform recoverable actions which may need to be kept in step with each other. They can achieve this by exchanging information during a synchronisation point, using the two-phase commit protocol.

Failures that occur during the in-doubt window within this protocol exchange can leave one or both units of recovery of the distributed transaction resources in an incomplete state awaiting resynchronisation following the re-establishment of communication between them.

If a resynchronisation attempt is carried out by two transaction processing systems simultaneously, this could lead to race conditions between the units of recovery that require additional logic to handle.

Conventionally, if it is not acceptable to wait for the transaction manager to resynchronize with the resources automatically, facilities can be used provided by the transaction manager to commit or roll back the database updates manually. In the “X/Open Distributed Transaction Processing: The XA Specification”, this is called making a heuristic decision. However, this should only be used as a last resort because of the possibility of compromising data integrity. For example, the resource updates may be mistakenly rolled back when all other participants have committed their updates.

In some cases, transaction resolution is required to complete successfully before further work can be started. In this case, conventional XA recovery is not satisfactory.

Known products provide elaborate mechanisms for the resolution of in-doubt units of recovery. An aim of the present invention is to provide a lightweight mechanism to achieve in-doubt resolutions.

### SUMMARY OF THE INVENTION

According to a first aspect of the present invention there is provided a method for in-doubt resolution in transaction processing involving at least two distributed transaction processing systems, comprising: re-establishing a connection between a first transaction processing system and a second transaction processing system following a failure; the first transaction processing system searching for any unresolved units of recovery and resynchronizing each unresolved unit of recovery with the second transaction processing system; when the first transaction processing system has finished processing its unresolved units of recovery, the second transaction processing system then searching for any unresolved units of recovery and resynchronizing each unresolved unit of recovery with the first transaction processing system.

According to a second aspect of the present invention there is provided a system for in-doubt resolution in transaction processing, comprising: a first transaction processing system; a second transaction processing system wherein, the first and second transaction processing systems have a network connection for coordinating distributed units of recovery; means for re-establishing a connection between the first transaction processing system and the second transaction processing system following a failure; the first transaction processing system including: means for searching for any unresolved units of recovery and means for resynchronizing each unresolved unit of recovery with the second transaction processing system; the second transaction processing system including; means for searching for any unresolved units of recovery and means for resynchronizing each unresolved unit of recovery with the first transaction processing system, wherein the means for searching and the means for resynchronizing of the second transaction processing system are activated after the first transaction processing system has no more unresolved units of recovery.

According to a third aspect of the present invention there is provided a computer program product stored on a computer readable storage medium for in-doubt resolution in transaction processing involving at least two distributed transaction processing systems, comprising computer readable program code means for performing the steps of: re-establishing a connection between a first transaction processing system and a second transaction processing system following a failure; the first transaction processing system searching for any unresolved units of recovery and resynchronizing each unresolved unit of recovery with the second transaction processing system; when the first transaction processing system has finished processing its unresolved units of recovery, the second transaction processing system then searching for any unresolved units of recovery and resynchronizing each unresolved unit of recovery with the first transaction processing system.

The solution describes an optimized message exchange during the recovery phase that allows processing to be completed without the need to resolve potential race conditions that might otherwise result from both transaction processing systems simultaneously attempting to resynchronize work over a connection.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a distributed transaction processing environment in which the present invention may be implemented;

FIG. 2 is a block diagram of a computer system in which the present invention may be implemented;

FIG. 3 is a schematic flow diagram of an initial exchange of information between transaction processing systems in accordance with an aspect of the present invention;

FIGS. 4A and 4B are schematic flow diagrams of a resynchronization process between transaction processing systems in accordance with another aspect of the present invention; and

FIGS. 5A and 5B are flow diagrams of methods of a resynchronization process between transaction processing systems in accordance with further aspects of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

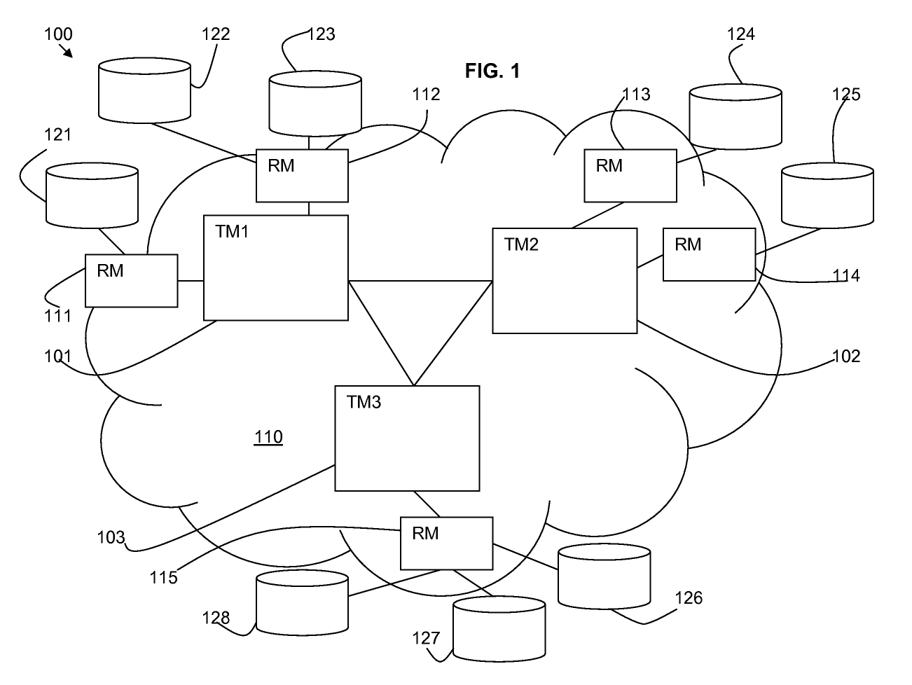

Referring to FIG. 1, an example arrangement of a distributed transaction environment 100 is shown. A distributed transaction environment 100 includes multiple transaction processing systems in the form of transaction mangers 101-103 which use a protocol to work together across a network 110 to carry out transactions or global units of recovery across multiple resources 121-128. The multiple resources 121-128 used to carry out a transaction are each in communication with a resource manager 111-115.

A given transaction manager 101 is responsible for creating and managing a distributed transaction that encompasses all operations against a set of the transaction resources 121-128. Distributed transactions, as with other transactions, must have atomicity guarantees for the outcome of the global unit of recovery. A common algorithm for ensuring correct completion of a distributed transaction is the two-phase commit protocol.

Each distributed transaction has a set of transaction managers 101-103 to which the transaction resources 121-128 register. A leader, the coordinator transaction manager 101, exists for each transaction to coordinate the two-phase commit protocol for the transaction. However, the coordinator role can be transferred to another transaction manger 102-103 for performance or reliability reasons. The transaction resources 121-128 exchange messages with their respective transaction mangers 101-103. The relevant transaction mangers 101-103 communicate among themselves to execute the two-phase commit protocol “representing” the respective resources 121-128 for terminating that transaction. With this architecture, the protocol is fully distributed and does not need any central processing component or data structure.

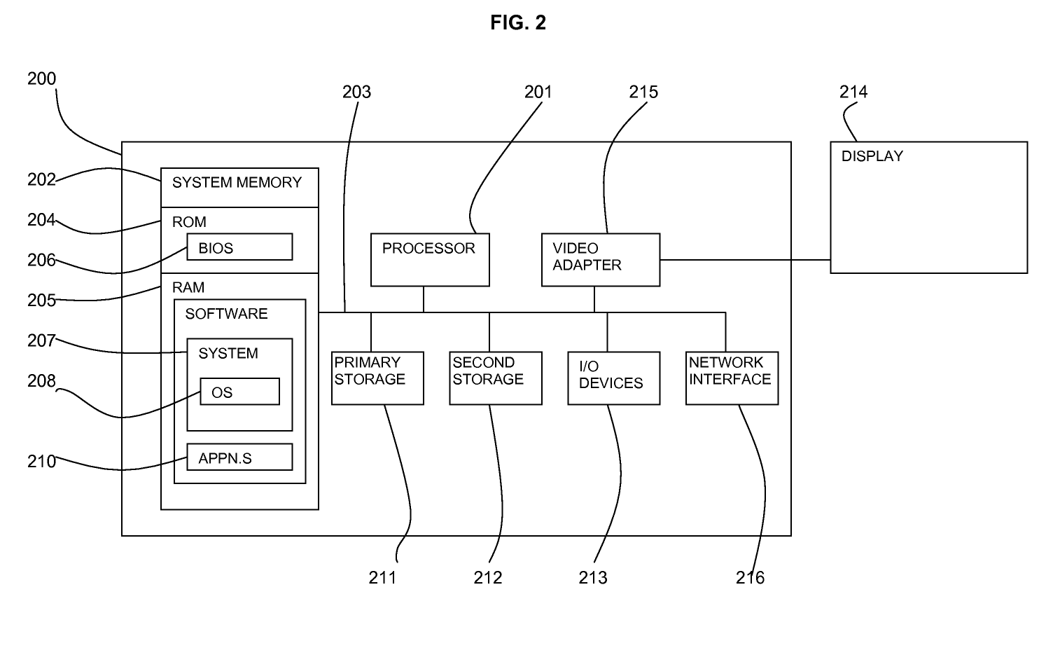

Referring to FIG. 2, an exemplary system for implementing a data processing system 200 such as a transaction manager or resource manager is described. The data processing system 200 is suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

A unit of recovery is the processing done by a transaction manager for an application program, which changes data from one point of consistency to another. A point of consistency, also called a syncpoint or commit point, is a point in time when all the recoverable data that an application program accesses is consistent.

A unit of recovery begins with the first change to the data after the beginning of the program or following the previous point of consistency; it ends with a later point of consistency. In this example, the application program makes changes to resources. The application program can include more than one unit of recovery or just one. However, any complete unit of recovery ends in a commit point.

For example, a bank transaction transfers funds from one account to another. First, the program subtracts the amount from the first account, account A. Then, it adds the amount to the second account, B. After subtracting the amount from A, the two accounts are inconsistent and transaction cannot commit. They become consistent when the amount is added to account B. When both steps are complete, the program can announce a point of consistency through a commit, making the changes visible to other application programs.

An in-doubt transaction is a global unit of recovery that was left in an in-doubt state. This can occur in a global transaction when a transaction manager becomes unavailable after successfully completing the first phase, or the PREPARE phase, of the two-phase commit, but has not completed the second phase.

A resynchronization process attempts to complete all in-doubt transactions and will either commit or rollback. In this process, a transaction manger connects to the resources involved in each in-doubt transaction and resends the transaction outcome. After all data sources complete the transaction, the transaction manger marks this in-doubt transaction complete. If any resource cannot complete the transaction, the transaction manager retries the resynchronization process during the next time interval.

Prior art systems support heuristic processing by manual recovery of in-doubt transactions, if it is not possible to wait for the resynchronization process to automatically resolve them. Transaction managers coordinate their own resource managers, or forward requests to external resource managers that are involved in a distributed unit of recovery. The transaction managers have to support the Sync Level 2 form of the two-phase commit protocol in order for them to take part in the resynchronization operations described below. Sync level 2 indicates that a transaction manager has the capability to perform recoverable operations of distributed units of recovery that have suffered a failure during synchronizing.

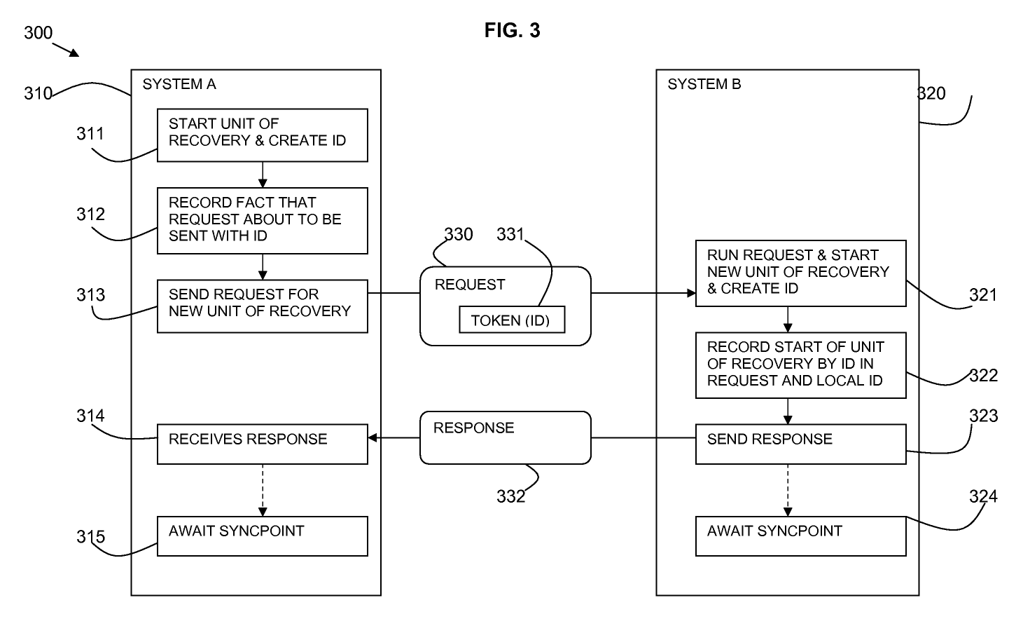

Referring to FIG. 3, a schematic flow diagram 300 illustrates a method of exchanging information between two transaction processing systems 310, 320, as required in the described method and system. The two systems 310, 320 are referred to as an initiating system 310 and a partner system 320. Information is exchanged which is needed should a resynchronization attempt be driven.

In the described method and system, a transaction processing system 310 (system A), such as a transaction manager, which is the initiating system starts 311 a unit of recovery and in doing so generates a unique identifier for it. System A 310 wishes to schedule another unit of recovery to start in an adjoining transaction processing system 320 (system B) which is a partner system in a transaction. Just before a request is sent to system B 320 through the network by system A 310, system A 310 records 312 the fact that this interaction is about to take place. System A 310 does not know the identity of system B's unit of recovery and so it is unable to store this data.

System A 310 sends 313 a request 330 to system B 320 together with a token 331 with the identifier of the unit of recovery of the task on system A 31 0. At this point the initiating task does not know the identity of the unit of recovery it is about to schedule and leaves that information blank in its record of the interaction. The token 331 uniquely distinguishes the unit of recovery in system A 310 from all others running on the same system 310.

System B 320 runs 321 the request 330 and starts a new unit of recovery to service the request 330 with its own unique identifier. System B 320 records 322 that this unit of recovery was started by the identifier sent with the request 330, and the identifier of system A 310 (the connection identifier). System B 320 sends 323 a response 332 to system A 310, which receives 314 the response.

At this point, there is a record on one system (system A 310) that knows its own unit of recovery, and one on the other system (system B 320) that knows both identifiers for the local and remote units of work.

The systems 310, 320 then await 315, 324 a syncpoint. Should a failure occur during the in-doubt phase of this global transactions syncpoint, then any resynchronization operation will depend on which system 310, 320 initiates this operation.

No further reference is made to the token 331 during the normal execution of the units of recovery. However, should a failure of either system 310, 320 or of their shared connection occur, then this token 331 is needed to tie both units of recovery together during any resynchronization attempt that may be made.

If system B 320 is the initiator of the resynchronization, then its records directly identify the unit of recovery in system A. However, if system A 310 is the initiator, then its record contains only the local (system A) unit of recovery's identifier. Therefore, system B, on receipt of a resynchronization message from system A with system A's unit of recovery identifier in it, then has to search through its own records to find a record that contains this information. From this record, system B can find the corresponding identifier of the unit of recovery that system B is managing.

When a connection is acquired between two systems after a communication termination between the two systems, messages may be exchanged to establish the capabilities of each system. Within this exchange are indicators of whether each system has retained recovery information relating to any outstanding work that was running when communication terminated between the systems. This allows each system to decide whether it will attempt to resynchronize any outstanding work resulting from an earlier failure.

Both systems could choose to do so concurrently and, if they did so, then there exists the real possibility that a resynchronization race might occur should both systems simultaneously attempt to complete the work associated with a pair of units of recovery. Under these circumstances, additional logic is needed to avoid race conditions. The described method and system avoid the overhead of race condition logic by allowing one system to initiate a single resynchronization attempt while the other participates in it. This agreement may be reached by various known methods. For example, each transaction manager may have a unique identifier and the resynchronization initiator is designated as the transaction manager with the highest (or lowest) value of identifier.

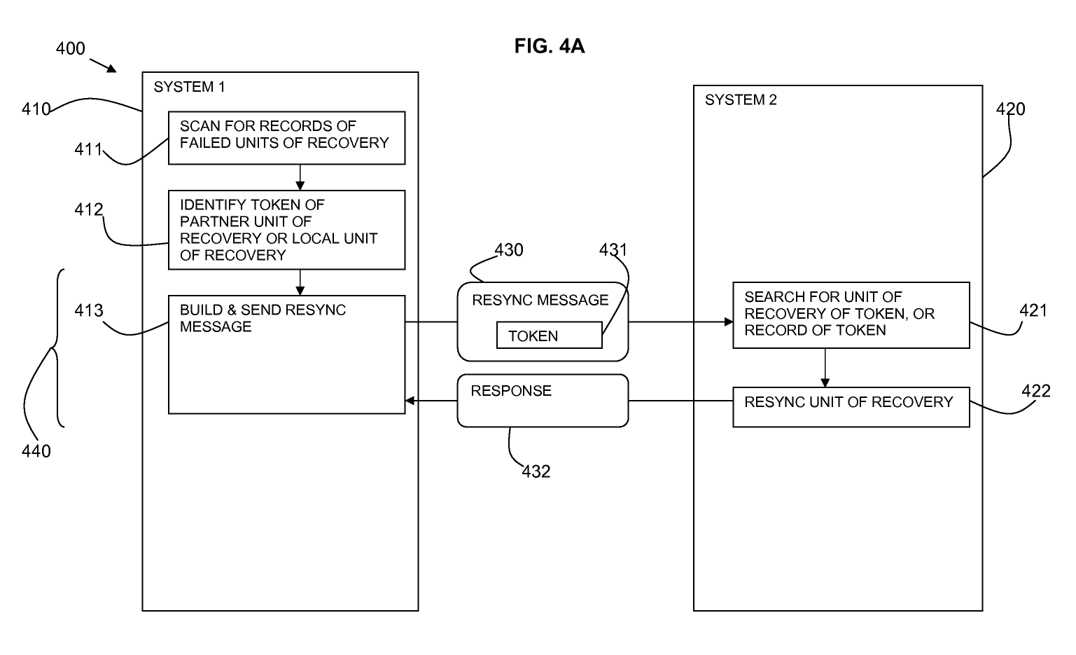

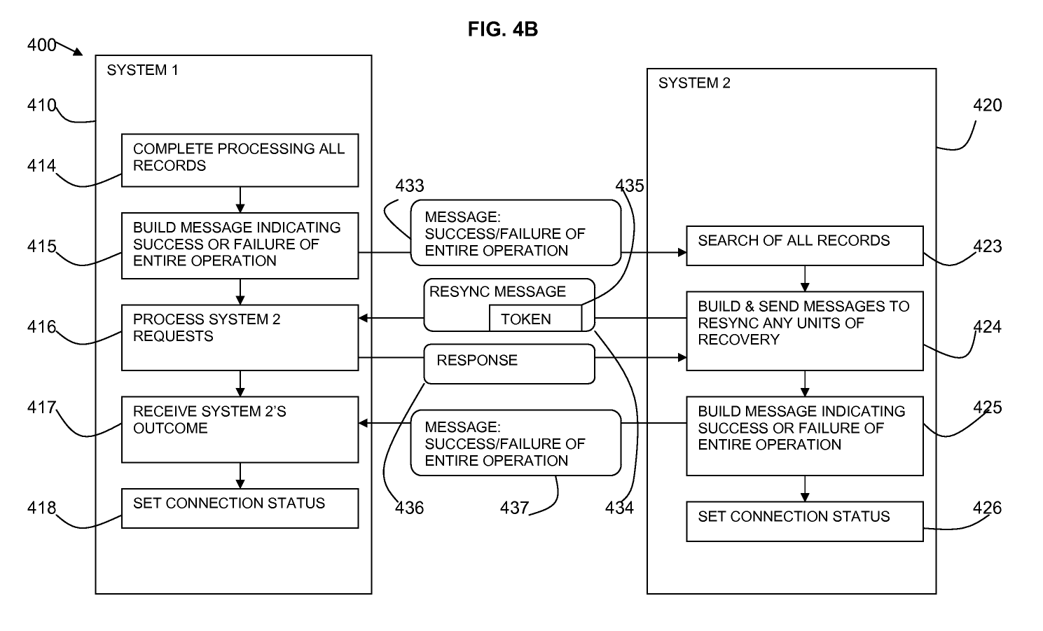

Referring to FIGS. 4A and 4B, a schematic flow diagram 400 of the process of resynchronization carried out by two transaction processing systems 410, 420 is illustrated. The system 410 that initiates the resynchronization attempt is referred to as the initiating system 410. This need not be the same system as the initiating system 310 of FIG. 3.

The initiating system 410 first searches 411 for any record that it might have of units of recovery that failed in-doubt or while committed and waiting on a acknowledgement that their partner unit of recovery has also done so at the point of the failure between the two systems.

Within each record located there may be a token identifying the partner unit of recovery; if not, then the token identifying the local unit of recovery is always present. One of these tokens is identified 412 for use in the resynchronization message. A blank field for the partner unit of recovery indicates during a resynchronization operation that a partner system will need to search for a unit of recovery rather than find one that is uniquely identified.

The system then builds and sends 413 a resynchronization message 430 containing one of these tokens 431 to the partner system 420. The partner system 420 then searches 421 for the unit of recovery identified by the token 431. If a unit of recovery is not found, the partner system 420 then looks for a record that it has containing the token 431, which can then be used to find the identity of the local unit of recovery. The unit of recovery in the partner system 420 is resynchronized 422 and a response 432 sent to the initiating system 410. In this way, the state for a pair of units of recovery can be found, after which they can be resynchronized.

The above sub-method 440 of resynchronizing units of recovery between the initiating and partner systems 410, 420 is repeated for all failed units of recovery found in the initiating system 410.

Referring to FIG. 4B, once the initializing system 410 has completed 414 the processing of all the records that it can find, it then builds 415 a message 433 indicating the success or failure of this entire operation and sends it to the partner system 420.

The partner system 420 then carries out a search 423 of its own records. It is then the turn of the partner system 420 to carry out the equivalent of the sub-method 440 of resynchronizing units of recovery between the partner and initiating systems 420, 410. This involves building and sending 424 resynchronization messages 434 back to the initiating system 410 to attempt to resynchronize any units of recovery that it finds. The resynchronization messages 434 include a token 435 identifying the unit of recovery on the initiating system 410. The initiating system 410 processes 416 the partner system requests 416 and sends a response 436 to each resynchronization message 434.

Once this processing completes, the partner system 420 returns 425 a message 437 to the initiating system 410 indicating the success or failure of its overall resynchronization attempt. The initiating system 410 receives 417 the partner system's 420 outcome. Both the systems 410, 420 then set their connection status 426, 418.

At this point the resynchronization process concludes, both systems are aware of the outcome of the operations that they have carried out, and can then decided whether to place the connection between them into service or not.

The processing carried out by two transaction processing systems 410, 420 allows them to attempt automatically to resynchronize any unresolved units of recovery following reestablishment of communications between the systems.

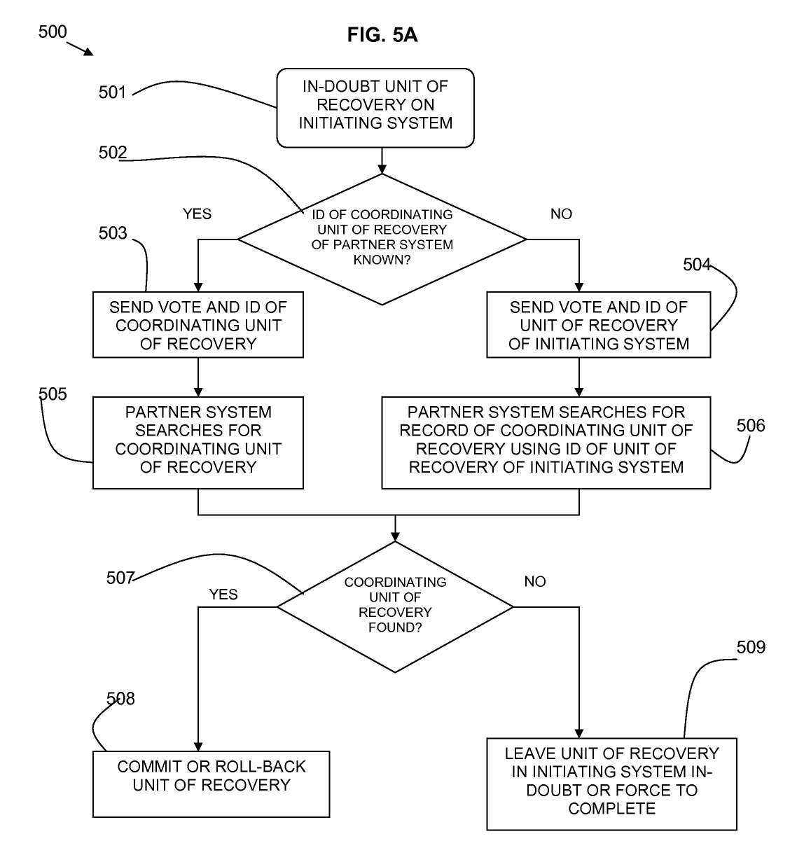

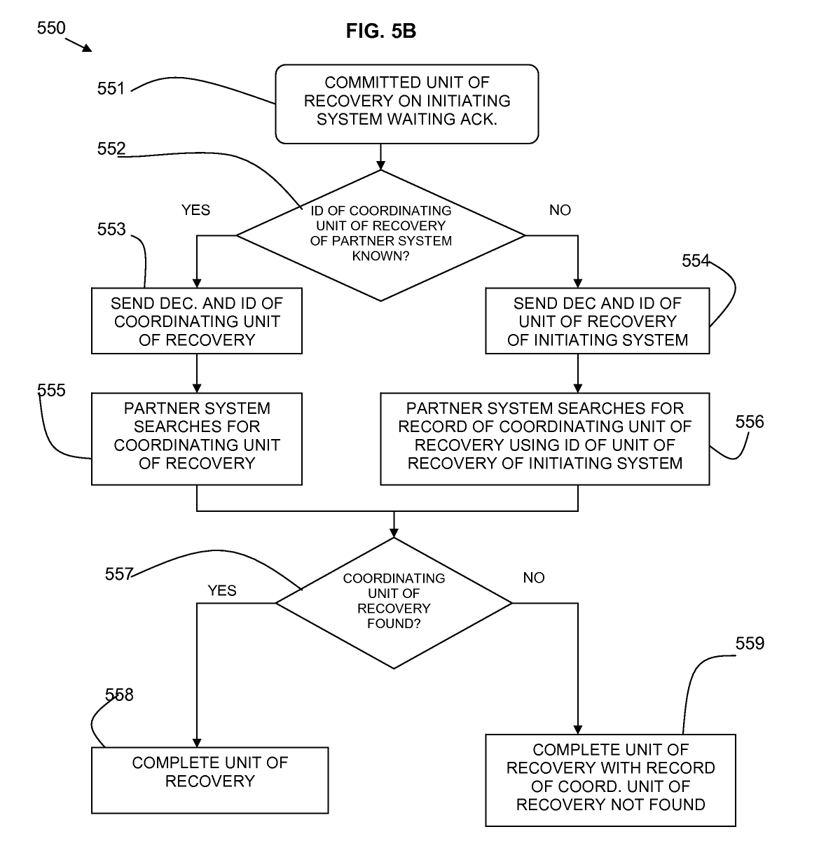

The information that is sent from one system to the other during the sub-method 440 consists of the following processes shown in FIGS. 5A and 5B

Referring to FIG. 5A, a flow diagram 500 is shown of the process for each initiating system local unit of recovery that is in-doubt 501. It is determined 502 if the identifier of the coordinating unit of recovery on the partner system is known. If it is known, the vote (indicating the outcome of a request) of the local unit of recovery and the identifier of its coordinating unit of recovery are sent 503 to the partner system. If it is not known, the vote of the local unit of recovery is sent 504 with the identifier of the local unit of recovery.

The partner system then looks for the coordinating unit of recovery. If the identifier of the coordinating unit of recovery has been sent 503, the partner system searches 505 for this identifier. If the identifier of the local unit of recovery has been sent 504, the partner system searches 506 for a record of the coordinating unit of recovery using the identifier of the local unit of recovery.

It is then determined 507 if the coordinating unit of recovery has been found. If found, the partner system responds 508 with a decision for the global unit of recovery. This causes the initiating system unit of recovery to be committed or rolled-back. Further messages may then be exchanged between each system indicating that their own units of recovery have been completed and can be forgotten by each system. In the case that the coordinating unit of recovery cannot be found, then the initiating system unit of recovery is either left in-doubt or, if configured to do so, can be forced to complete using an arbitrary decision, while recording the potential data mismatch between the two systems 509.

Referring to FIG. 5B, a flow diagram 550 is shown of the process for each initiating system unit of recovery that is committed and waiting on an acknowledgement that its partner system has also committed its updates 551.

It is determined 552 if the identifier of the coordinating unit of recovery on the partner system is known. If it is known, the decision of the local unit of recovery and the identifier of its coordinating unit of recovery are sent 553 to the partner system. If it is not known, the decision of the local unit of recovery is sent 554 with the identifier of the local unit of recovery.

The partner system then looks for the coordinating unit of recovery. If the identifier of the coordinating unit of recovery has been sent 553, the partner system searches 555 for this identifier. If the identifier of the local unit of recovery has been sent 554, the partner system searches 556 for a record of the coordinating unit of recovery using the identifier of the local unit of recovery.

It is then determined 557 if the coordinating unit of recovery has been found. If found, the partner system proceeds to commit its updates. The partner system then responds indicating that it has done this and the unit of recovery is completed 558. If the coordinating unit of recovery could not be found, the unit of recovery may fail or complete with any discrepancies resulting from the partner system not finding its coordinating unit of recovery being recorded 559.

Each transaction processing system can choose to either send individual resynchronization requests for single units of recovery to their partner system, or may combine some or all requests into the messages that they then transmit. When requests are combined together the overhead of the network transmission costs may be reduced, but the logic needed to build and dissemble messages becomes more complex.

The described solution has simplicity advantages, principally the ease of diagnosis of failure due to fewer failure modes.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for in-doubt resolution in transaction processing involving at least two distributed transaction processing systems, comprising:
re-establishing a connection between a first transaction processing system and a second transaction processing system following a failure;
the first transaction processing system searching for any unresolved units of recovery and resynchronizing each unresolved unit of recovery with the second transaction processing system;
when the first transaction processing system has finished processing its unresolved units of recovery, the second transaction processing system then searching for any unresolved units of recovery and resynchronizing each unresolved unit of recovery with the first transaction processing system.

2. The method as claimed in claim 1, wherein an unresolved unit of recovery in a first transaction processing system is an in-doubt local unit of recovery, or a committed local unit of recovery with an uncommitted coordinating unit of recovery in a second transaction processing system.

3. The method as claimed in claim 1, wherein a failure is a failure in one of the transaction processing systems or in a connection between transaction processing systems.

4. The method as claimed in claim 1, including:
the first transaction processing system sending a message indicating the final outcome of the resynchonizing of all the first transaction processing system's unresolved units of recovery, the message indicating to the second transaction processing system to start the searching and resynchronizing of all the second transaction processing system's unresolved units of recovery.

5. The method as claimed in claim 4, including:
the second transaction processing system sending a message indicating the final outcome of the resynchonizing of all the second transaction processing system's unresolved units of recovery;
if the final outcomes of the first transaction processing system's resynchronization and the second transaction processing system's resynchronization are successful, putting the connection into service.

6. The method as claimed in claim 1, wherein searching for unresolved units of recovery uses an identifier to search for units of recovery with the identifier and for records of operations in a unit of recovery referencing the identifier.

7. The method as claimed in claim 2, wherein when an unresolved unit of recovery in a first transaction processing system is an in-doubt local unit of recovery, the resynchronization includes:
sending a request for resynchronization to the second transaction processing system including an identifier of the local unit of recovery or an identifier of a coordinating unit of recovery;
the second transaction processing system searching for the coordinating unit of recovery using the identifier;
the second transaction processing system committing or aborting the coordinating unit of recovery, if found.

8. The method as claimed in claim 7, wherein if the second transaction processing system cannot find the coordinating unit of recovery, the local unit of recovery is left unresolved, or is resolved while recording the failure.

9. The method as claimed in claim 2, wherein when an unresolved unit of recovery in a first transaction processing system is a committed local unit of recovery with an uncommitted coordinating unit of recovery in a second transaction processing system, the resynchronization includes:
sending a decision for the local unit of recovery to the second transaction processing system including an identifier of the local unit of recovery or an identifier of a coordinating unit of recovery;
the second transaction processing system searching for the coordinating unit of recovery using the identifier;
the second transaction processing system committing or aborting the coordinating unit of recovery, if found.

10. The method as claimed in claim 9, wherein if the second transaction processing system cannot find the coordinating unit of recovery, the local unit of recovery is left unresolved, or is resolved while recording the failure.

11. The method as claimed in claim 1, including:
a first transaction processing system creating a local unit of recovery;
the first transaction processing system sending a request to a second transaction processing system to create a coordinating unit of recovery, the request including an identifier of the local unit of recovery; and
the second transaction processing system starting a coordinating unit of recovery and recording the identifier in association with the coordinating unit of recovery.

12. The method as claimed in claim 11, wherein the first transaction processing system maintains a record of the request with the identifier.

13. The method as claimed in claim 11, wherein the second transaction processing system records an identifier of the first transaction processing system from which the request is received in association with the coordinating unit of recovery.

14. The method as claimed in claim 11, wherein in the event of a failure, one of the first and second transaction processing systems uses the identifier to locate the unit of recovery on the other of the first and second transaction processing systems to resynchronize the units of recovery.

15. A system for in-doubt resolution in transaction processing, comprising:
a first transaction processing system;
a second transaction processing system wherein, the first and second transaction processing systems have a network connection for coordinating distributed units of recovery;
means for re-establishing a connection between the first transaction processing system and the second transaction processing system following a failure;
the first transaction processing system including:
means for searching for any unresolved units of recovery and means for resynchronizing each unresolved unit of recovery with the second transaction processing system;
the second transaction processing system including;
means for searching for any unresolved units of recovery and means for resynchronizing each unresolved unit of recovery with the first transaction processing system, wherein the means for searching and the means for resynchronizing of the second transaction processing system are activated after the first transaction processing system has no more unresolved units of recovery.

16. The system as claimed in claim 15, including:
the first transaction processing system including means for sending a message indicating the final outcome of the resynchonizing of all the first transaction processing system's unresolved units of recovery, the message indicating to the second transaction processing system to start the searching and resynchronizing of all the second transaction processing system's unresolved units of recovery.

17. The system as claimed in claim 16, including:
the second transaction processing system including means for sending a message indicating the final outcome of the resynchonizing of all the second transaction processing system's unresolved units of recovery;
the system including means for putting the connection into service, if the final outcomes of the first transaction processing system's resynchronization and the second transaction processing system's resynchronization are successful.

18. The system as claimed in claim 15:
a first transaction processing system including means for creating a local unit of recovery;
the first transaction processing system including means for sending a request to the second transaction processing system to create a coordinating unit of recovery;
the request including an identifier of the local unit of recovery; and
the second transaction processing system including means for creating a coordinating unit of recovery and means for recording the identifier in association with the coordinating unit of recovery.

19. The system as claimed in claim 18, wherein the first transaction processing system includes means for storing a record of the request with the identifier.

20. A computer program product stored on a computer readable storage medium for in-doubt resolution in transaction processing involving at least two distributed transaction processing systems, comprising computer readable program code means for performing the steps of:
re-establishing a connection between a first transaction processing system and a second transaction processing system following a failure;
the first transaction processing system searching for any unresolved units of recovery and resynchronizing each unresolved unit of recovery with the second transaction processing system;
when the first transaction processing system has finished processing its unresolved units of recovery, the second transaction processing system then searching for any unresolved units of recovery and resynchronizing each unresolved unit of recovery with the first transaction processing system.
